(19) United States
(12) Patent Application Publication
(10) Pub. No.: US 2005/0034120 A1
(43) Pub. Date: Feb. 10, 2005

(54) Systems and methods for cooperatively building public file packages

(75) Inventors: Jeffrey O. Fisher, Austin, TX (US); Satish B. Reddy, Austin, TX (US)

Correspondence Address: Barry S. Newberger;P.O. Box 50784, 1201 Main Street, Dallas, TX, 75250-0784, US

(73) Assignee: International Business Machines Corperation, Armonk, NY (US)

(21) Appl. No.: 10/636,988

(22) Filed: Aug. 7, 2003

(51) Int. Cl. G06F 9/445; G06F 9/44

(52) U.S. Cl. 717/175; 717/169

(57) ABSTRACT

A mechanism to build public file packages across multiple hosts and platforms is provided. A file package is created and builder processes (or simply “builders”) distributed among the hosts build a file set into the package. The builder may be represented by an executable file deployed on the host that may be, but is not necessarily, the target of the file set. A set of builders may be associated with a particular file package and invalid builders may be precluded from “working” on the package. A build event may be associated with the build and triggered when all builders have completed their respective builds.

### CROSS REFERENCE TO RELATED APPLICATIONS

The present invention is related to the following U.S. patent applications which are incorporated herein by reference, and filed concurrently herewith:

Ser. No. ______, (Attorney Docket No. AUS9-2003-0281US1) entitled “Systems and Methods for a Bootstrap Mechanism for Software Testcase Execution”;
Ser. No. ______, (Attorney Docket No. AUS9-2003-0126US1) entitled “Systems and Methods for Packaging Files Having Automatic Conversion Across Platforms”; and

Ser. No. ______, (Attorney Docket No. AUS9-2003-0125US1) entitled “Systems and Methods for Synchronizing Software Execution Across Data Processing Systems and Platforms.”

### TECHNICAL FIELD

The present invention relates to the field of software automation in data processing systems, and in particular, to the building of public file packages by a multinode operation, and which is adapted to different runtime environments in which the package builder processes execute.

### BACKGROUND INFORMATION

Software applications in modern enterprise data processing environments typically constitute many thousands of lines of source code and implement complex functionality. For example, the Apache web server, a widely available, open source web server, comprises at least 80,000 lines of source code. The Linux operating system, exceeds 1.6 million lines of source code. Testing such software products is a time-consuming task. Testing of software involves the invocation of the program functionality, and, typically, validating the correctness of the results of that functionality.

The testing of software includes the execution of one or more testcases which are designed to exercise the operations that implement the functionality of the software under task. The testcases are run to verify that the software under test does not fail for the testcase conditions, and additionally verify that the output generated is correct.

Generally, software testing includes activities that are performed by members of the software development team, and other activities that are automated, that is, performed by another software program.

Data processing systems, particularly in an enterprise environment, typically constitute a networked data processing system in which a set of commonly-accessed resources provide services to a multiplicity of users attached to the network. These services may include electronic mail (e-mail) services, Internet access, distributed computing services, input/output services, such as printing, etc. Moreover, the software deployed to provide such services as well as to access those services may be deployed across a multiplicity of platforms, that is, operating systems. Corresponding thereto, in the testing of a software product, may be desirable to run testcases across multiple hosts and platforms. Such a multihost testcase includes multiple testcase processes. Additionally, multiple testcase processes may run on a single host.

The testcases typically include multiple software files containing executable code and data. The set of files to execute the testcase on a particular host may depend on the host and runtime environment. The runtime environment may include the operating system deployed on the particular host, program environment (byte-code interpreted, such as Java or native) and the results of prior testcase runs.

The acquisition and deployment of the files to effect a particular testcase run on each host may represent a substantial effort in the software test cycle.

Consequently, there is a need in the art for systems and methods to automate the acquisition and deployment of software testcase files, across multiple hosts and runtime environments. In particular, there is a need for a mechanism by which a runtime-aware process may build the requisite files based on its environment into a public file package.

### SUMMARY OF THE INVENTION

The present invention addresses the aforementioned needs. Accordingly, there is provided in one form, a computer program product embodied in a tangible storage medium for building file packages. The program product includes programming instructions for receiving a build request. The build request includes a first set of file package parameters from a builder process. If the set of parameters includes a file specification, a file repository containing a corresponding file is accessed and stored in the file package. Additionally, a state of the builder process is set, wherein the state is a member of a predetermined set of builder process states.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### DETAILED DESCRIPTION

A mechanism to build public file packages across multiple hosts and platforms is provided. A file package is created and builder processes (or simply “builders”) distributed among the hosts build a file set into the package. The builder may be represented by an executable file deployed on the host that may be, but is not necessarily, the target of the file set. A set of builders may be associated with a particular file package and invalid builders may be precluded from “working” on the package. A build event may be associated with the build and triggered when all builders have completed their respective builds.

In the following description, numerous specific details are set forth to provide a thorough understanding of the present invention. For example, particular command or request names and parameter keywords, or particular file transfer protocols and file archive formats may be described, however, it would be recognized by those of ordinary skill in the art that the present invention may be practiced without such specific details, and in other instances, well-known circuits have been shown in block diagram form in order not to obscure the present invention in unnecessary detail. Refer now to the drawings wherein depicted elements are not necessarily shown to scale and wherein like or similar elements are designated by the same reference numeral for the several views.

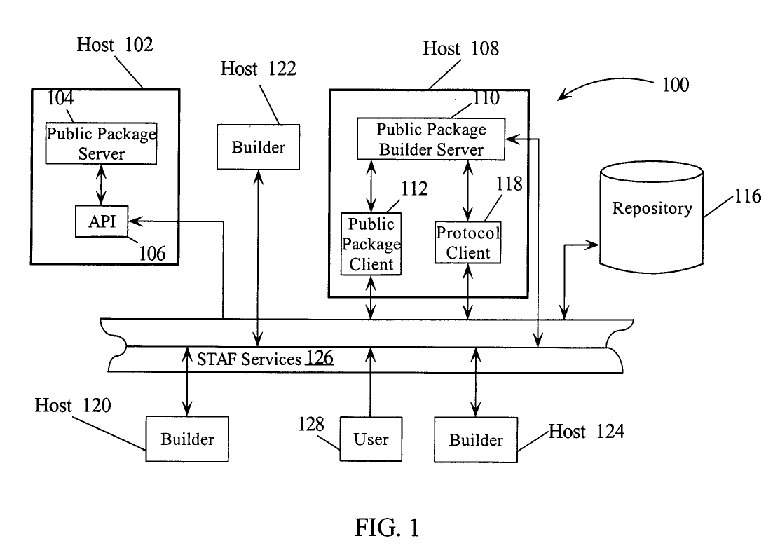

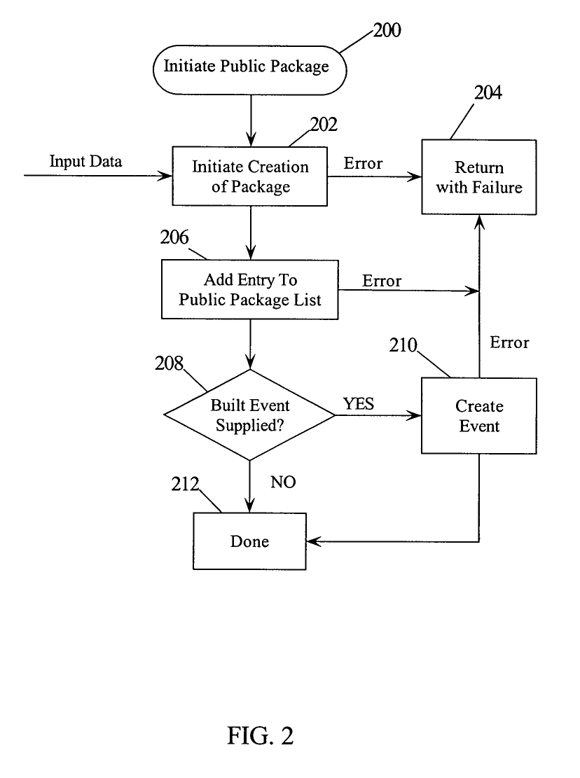

FIG. 1 illustrates an architecture 100 for a public file package builder system (or facility) in accordance with the present inventive principles. Host 102 includes a public package server 104, and an associated application program interface (API) 106. A public package mechanism that may be used by public package server 104 is described in the U.S. patent application Ser. No. ______, entitled “Systems and Methods for Packaging Files Having Automatic Conversion Across Platforms,” which is hereby incorporated herein in its entirety by reference. Host 108 includes public package builder server 110. The operation of public package builder server 110 will be described in conjunction with FIGS. 2-5, below. Public package client 112 provides an interface between public package builder server 110 and public package server 104. Commands may be issued to public package server 104 via public package client 112, which commands may be sent to public package server 104 via network 114. (Although illustrated in FIG. 1 as deployed on separate hosts, it would be appreciated by those of ordinary skill in the art that public package server 104 and public package builder server may, alternatively, be deployed on the same host.)

Additionally, files to be included in a package being built in accordance with the present inventive principles may be located in a repository 116. The repository may be configured using a multiplicity of file archiving and transfer mechanisms. One such is a File Transport Protocol (FTP) directory, or similar directories using the Hypertext Transfer Protocol (HTTP) as the file transport protocol. Other file repository schemes are the Configuration Management and Version Control system (CMVC), a proprietary revision control system from IBM Corporation, and the Concurrent Version System (CVS), an open source file revision and control system based on a shared directory architecture, and ClearCase®, a software configuration management system from Rational Software, owned by IBM Corporation, Armonk, N.Y. For the purposes herein, the repository may be any of the commonly used file repository mechanisms. File repository client 118 provides an interface between public package builder server 110 and repository 116. File repository client 118 communicates with repository 116 using the appropriate repository protocol and gets files from the repository.

The foregoing is exemplary, and an embodiment of the present invention may include any number of hosts having builders deployed thereon. Additionally, any host may have multiple builders to build different file sets for deployment on the host.

A builder may request public package builder services from public package builder server 110 by sending commands via network 114. In particular, in an embodiment of the present invention, public package builder services may be implemented as a STAF service. STAF (Software Test Automation Framework) is an open-source, multi-platform framework that provides such services as process invocation, resource management, logging, and monitoring. STAF software and documentation are distributed electronically through SourceForge.net. SourceForge.net is a centralized location for Open Source developers to control and manage Open Source software development. SourceForge.net provides hosting to Open Source software development projects. The Uniform Resource Locator for the STAF homepage at SourceForge.net is <http://staf.sourceforge.net/index.php>. In such an embodiment, public package builder services may be sent to public package builder server 110 as STAF services requests 126, which may be transported via network 114. Note that STAF is designed so that STAF services are able to receive commands entirely by text messages. Consequently, STAF provides the client user interface for STAF services.

The creation of the file package may be initiated by a user 128 requesting public package builder services from public package builder server 110 by sending commands via network 114. These requests may also be made as STAF services requests 126.

Refer now to FIG. 2 illustrating, in flowchart form a process 200 for initiating a public file package which may be used in conjunction with the builder processes to be described below. Note that the flowcharts provided herein are not necessarily indicative of the serialization of operations being performed in an embodiment of the present invention. Steps disclosed within these flowcharts may be performed in parallel. The flowcharts are indicative of those considerations that may be performed to produce the operation available to build public file packages in accordance with the present inventive principles. It is further noted that the order presented is illustrative and does not necessarily imply that the steps must be performed in the order shown.

In step 202, the creation of the file package is initiated, in response to input data from a user. User input may be supplied by a command line interface (CLI), and in an embodiment of the present invention configured in accordance with architecture 100, FIG. 1, may use STAF services 126 to transfer the commands to public package builder server 110. Commands may be in the form of a command word for example “start pubpkg” and a set of parameters in the form of a “keyword” followed by one or more “values.” Parameters may include, for example the public package name (“PUBPKGNAME”), for example “P1”. A list of builders (“BUILDER LIST”) for example {“PlBldr1”, “PlBldr2”, “PlBldr3”}, a build event name (“BUILDEVENT”), for example, “BldEventName” which, as described further hereinbelow, specifies an identifier of a build event which may be triggered by a build process, as discussed below, to signal a completion of the file package build. Step 202 may be performed by using the services of public package server 104 in an embodiment of the present invention in accordance with architecture 100, FIG. 1. A mechanism for building public file packages which may be used in a public package server, such as public package server 104, are described in the commonly owned co-pending U.S. patent Application Ser. No. ______, entitled “Systems and Methods for Packaging Files Having Automatic Conversion Across Platforms,” which is hereby incorporated herein in its entirety by reference. In initiating the public package, public package builder server 110, FIG. 1, may interface with public package server 104 via API 106 using public package client 112 which formats the corresponding commands to public package server 104 specified by API 106. Additional parameters may be included to specify a time duration after the expiration of which the package is automatically deleted. Such an auto deletion capability is provided in the aforementioned public package software mechanism described in the previously referenced U.S. patent application entitled “Systems and Methods for Packaging Files Having Automatic Conversion Across Platforms.” (In accordance therewith, a Autodel “AutoDelHours” parameter keyword value pair may be passed on the command line.) Other parameters that may also be included signal the process to permit overwriting of any preexisting files. For example, the public package mechanisms of the aforementioned U.S. patent application include an Overwrite parameter, which, if included as a command line parameter will permit the overwriting of preexisting files during the build of a public file package in accordance with the systems and methods therein. Note that in an embodiment of the present invention selected parameters may be made mandatory while others may be optional. For example, the public package name and builder list may be mandatory parameters. However, in an alternative embodiment, attributes of the public package that are commonly supplied through parameter-value pairs may be supplied with default values that may, optionally, be overwritten by explicitly passing a corresponding parameter-value pair in the command line. Additionally, system parameter values or similar parameters recoverable by a builder, such as a process ID (PID), may be used, to default parameters such as the public package name.

If an error in the creation of the public package occurs, process 200 returns with a failure in step 204. A diagnostic message indicating the cause of the error may be displayed on the user's CLI. Such errors may include keyword syntax errors, or simply a keyword that corresponds to no implemented parameter or an incorrect parameter value.

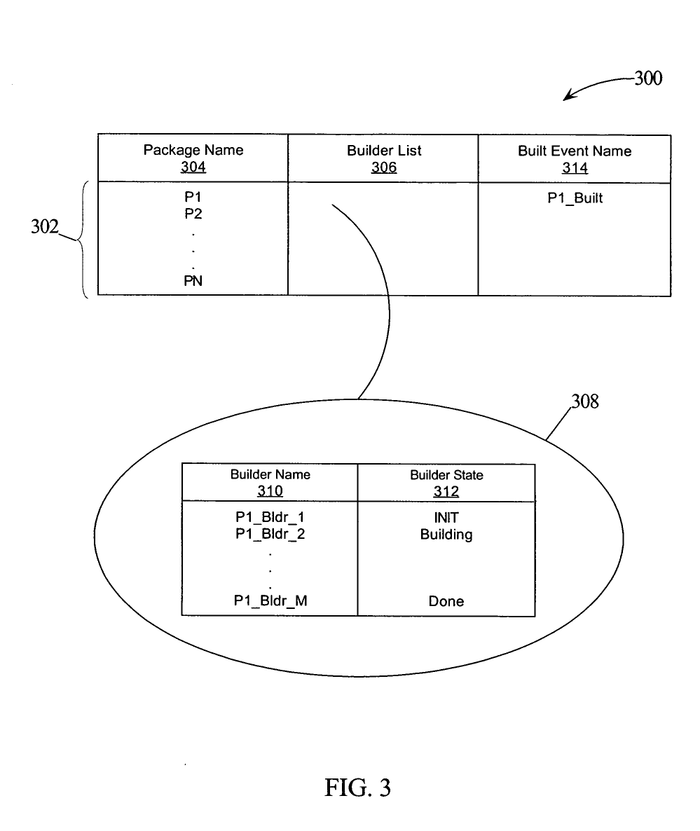

In step 206, an entry for the package being created is added to a list of public packages. A public package list may be a data structure maintained by a public package builder server 104 in an embodiment in accordance with architecture 100 in FIG. 1. The list of public packages may be stored by the public package server 104, FIG. 1. FIG. 3 schematically illustrates an exemplary package list structure 300. Package list 300 includes a plurality, n, of entries 302, each entry associated with a file package, denoted “P1,” “P2,” . . . , “PN”. Package names may be stored in a field 304 in the corresponding entry 302. Additionally, each file package may have a list of builders, that is processes, each of which functions to autonomously build files into the package. Note that a builder list itself may be a data structure for holding information about a particular builder, for example, builder name and builder state. Builder lists where each package may be contained in a field 306 in the entry 302 corresponding to the package. Inset 308 illustrates an exemplary builder list for package “P1” in which a number, m, of builders are associated with that file package. The m builders may have an associated identifier or builder name 310, exemplified by the names “Builder1,” “Builder2,” . . . “BuilderM.” Additionally, each builder may have an associated builder state 312. These states are mnemonically denoted “INIT,” “BUILDING,” and “DONE.” The setting of the builder states will be described further hereinbelow. Note that in an embodiment of the present invention, a builder list field 306 may be implemented by storing a reference to the data structure 308.

An event name may also be associated with each public package. As discussed further hereinbelow, the event name may be used to specify an event to be triggered on completion of the build of the file packages by all of the associated builders. In the exemplary package list 300, package “P1” has an associated event named “P1_BUILT” contained in a Build Event Name field 314 in the entry 302 corresponding to package “P1.” The values contained in the data structure, such as package names and builder names may be provided as parameter keyword-value pairs in the command line initiating creation of the package, as previously discussed. If the operation of adding the entry to the public package list fails, that is unsuccessful, process 200 returns, in step 204, with a failure. For example, a runtime memory error may cause the operation to fail.

In step 208, if a built event is supplied, the event is created in step 210. In an embodiment of the present invention using STAF services, a STAF semaphore service may be used. STAF semaphores provide for named events. In such an embodiment, a STAF <hostname> SFM <BuiltEventName> may be used to create the event in step 210. Process 200 terminates in step 212. Returning to step 208, if a build event was not supplied, process 200 bypasses step 210 and terminates in step 212.

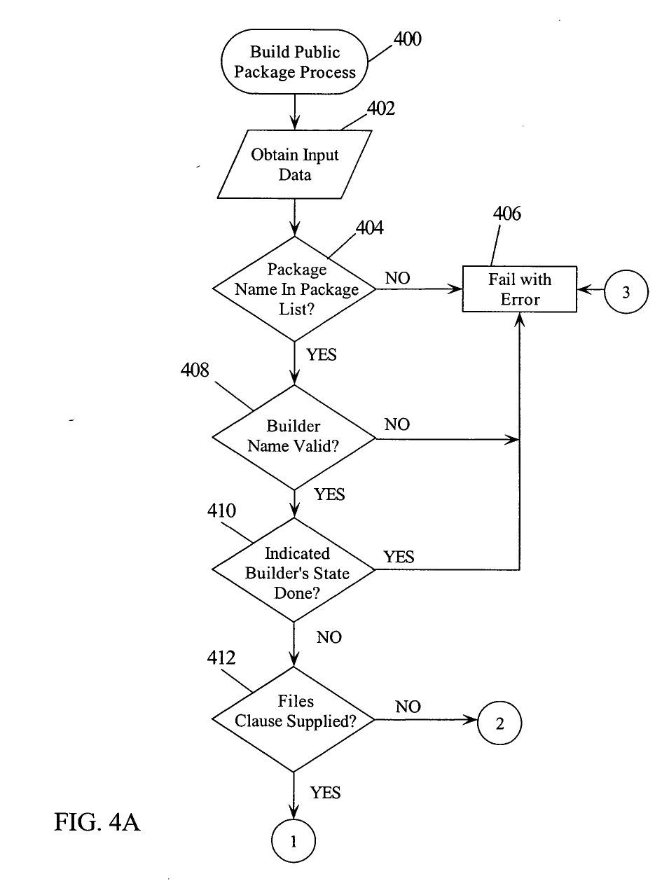

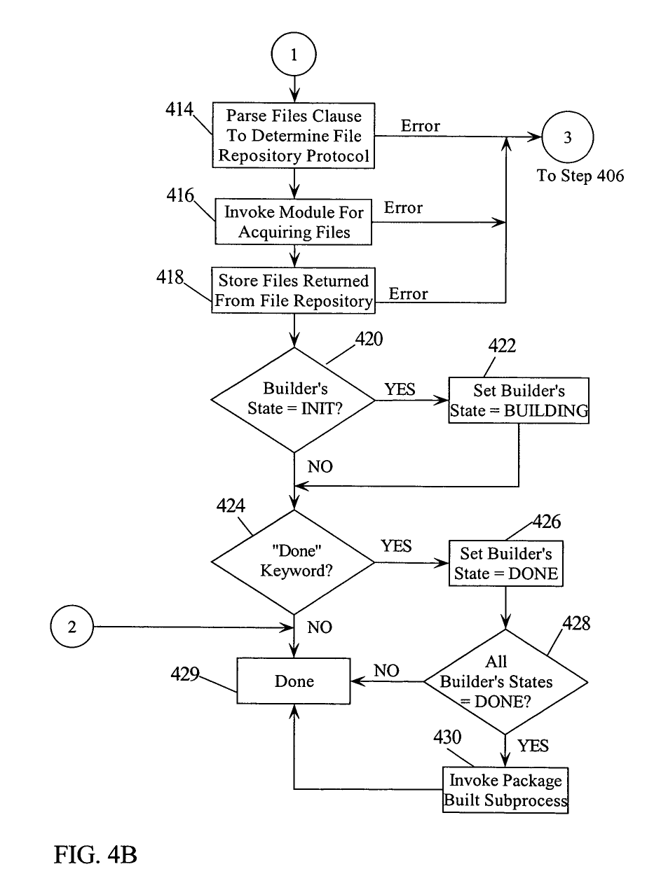

A process 400 for building a public file package in accordance with the present inventive principles is illustrated in flowchart form in FIGS. 4A and 4B. Process 400 may be a process performed by a public package builder server 110, FIG. 1, for example. Process 400 may be invoked by a builder (of which there may be one or more) as specified in the builder list for the particular software being built, as described above. Recall that a builder is a process that is deployed on a host (hosts 120, 122 and 124, FIG. 1, for example) and which may be executed to build a file set into the package that may be specific to the host. The builder may be an executable file that includes a set of input data to process 400. A builder executable file may be a shell script for example. (For the purposes herein, an executable file need not be restricted or limited to a native instruction binary file. Any file that includes code that may be executed without the need for an external compilation, regardless of the format may be an executable file. Such code may include shell scripts, scripts written in other scripting languages, for example Perl, or bytecode files executed by a virtual machine, such as Java class files. It would be understood by those of ordinary skill in the art that the present inventive principles may be applied in conjunction with any such executable code, and these embodiments would fall within the spirit and scope of the present invention.) An exemplary builder executable is discussed in conjunction with an application bootstrap mechanism that is described in the commonly owned co-pending U.S. patent application Ser. No. ______, entitled “Systems and Methods for a Bootstrap Mechanism for Software Testcase Execution,” which is hereby incorporated herein in its entirety by reference.

In step 402, the input data issued by a builder is received. Input data may include a “BUILD PUBPKG” request and a list of parameters in the form of, for example, keywords or keyword-value list pairs. In particular, a BUILD PUBPKG request may include a parameter specifying a list of files to be added to the file package under construction. Additional parameters include the name of the particular builder that invoked process 400, which parameter may be in the form of a keyword-value pair, such as BUILDER Builder_Name. (As noted above, any particular embodiment of the present invention may define a set of commands, associated keywords and keyword values, and the particular commands and keywords used do not implicate the present invention principles and such embodiments would be understood by those of ordinary skill in the art to fall within the spirit and scope of the present invention.

In step 404, it is determined if the input data includes a package name contained in the public package list, such as package list 300, FIG. 3. Recall that the public package list includes an entry for each public file package under construction or constructed. If the identifier, i.e. “name” of a file package supplied in the input data is not in the list, then, in step 406, process 400 fails and returns an appropriate error message, for example, NO_SUCH_PUBPKG.

The name of the builder invoking the process is tested against the list of builders for the particular file package being built in step 408. Recall that the entry for the file package in the public package list may include a list of builders “authorized” to build the package. These may have been supplied as input data to the initiate public package process, such as process 200, FIG. 2. If the builder is not valid in step 408, process 400 fails with an appropriate error message, such as NO_SUCH_BUILDER_NAME, in step 406.

In step 410, the state of the builder is determined from the corresponding entry on the builder list. If the state is DONE (or the equivalent), process 400 fails, in step 406, with an error message, such as BUILDER_IS_DONE.

Otherwise, in step 412, it is determined if a file specification is specified in the input data. This may be signaled by the presence of a parameter keyword, such as FILES, in the build request command line. Otherwise, if no files are specified, process 400 proceeds to step 420, discussed below. In step 414, the files parameter string, including the parameter values specifying the file pathname (which may include a directory path and a files specification) is parsed to determine the file repository protocol for accessing the file. As discussed above, protocols may include CMVC, HTTP, and FTP, however, the particular protocol does not implicate the present inventive principles, and would fall within the spirit and scope of the present invention. The protocol may be specified using, for example, the conventional “<scheme>://” notation. An exemplary file specification syntax for identifying files in different file repositories may include:

cmvc://<FullDirPath> <Filespec>

| | |
|---|---|
| FAMILY | <FamilyName> |
| RELEASE | <ReleaseName> |
| VERSION | <VersionName> |

http://<RestOfURL>
ftp://<Hostname> </FullDirPath> </Filespec>.

The protocol may be determined in these examples by parsing the file specification to the first “:”. If the protocol is not supported by the public package builder, process 400 returns with a failure, and may post an error message, such as PROTOCOL_NOT_SUPPORTED.

If the specified protocol is supported by the repository, in step 416 a module for acquiring the files is invoked. This may be performed in the architecture illustrated in FIG. 1 by invoking file repository client 118. Client 118 then interacts with the repository to attempt to access the particular files determined by the file specification. If the files access fails, process 400 returns with a failure, step 406. An error message indicating the failure, such as MATCHING_FILES_NOT_FOUND may be returned.

In step 418, files returned from the repository are stored. This may be performed, for example, by using the public package mechanism described in the above referenced U.S. patent application Ser. No. ______, entitled “Systems and Methods for Packaging Files Having Automatic File Conversion Across Platforms.” In particular, in step 418, the input data may be used to generate a CREATE FILES request which may be passed to the public package server embodying such systems and methods, for example public package server 104, FIG. 1. If an error condition is encountered, process 400 returns with a failure. Additionally, a message may be returned indicating the type of the error condition. For example, if a file specified to be stored already exists in the file package (without the OVERWRITE parameter) a message such as PUBPKG_FILE_COLLISION may be returned.

In steps 420-426, the state of the builder that invoked process 400 is set. Recall that the state of the builder may be maintained in a builder list in the corresponding entry of a package list, such as package list 300, FIG. 3, for the file package being built. If, in step 420 the current state of the builder is “INIT” (or the equivalent in an alternative embodiment of the present invention) the state is set to “BUILDING” (or the equivalent) in step 422. Otherwise step 420 falls through to step 424. In step 424, it is determined if the build request includes the “DONE” keyword. If so, the builder's state is set to “DONE” (or the equivalent) in step 426. In step 428, it is determined if the states of all builders for the package being built are in the “DONE” state. If not, process 400 ends in step 499.

Note that a particular builder may repeatedly invoke process 400 to build a set of files into the file package. Until the “DONE” (or equivalent) keyword is specified, the builder's state may remain “BUILDING” whereby steps 420 and 424 fall through to step 499.

Returning to step 428, if all builder's states are “DONE,” the build of the file package is complete, and in step 430 a “package built” subprocess is invoked and process 400 ends in step 499.

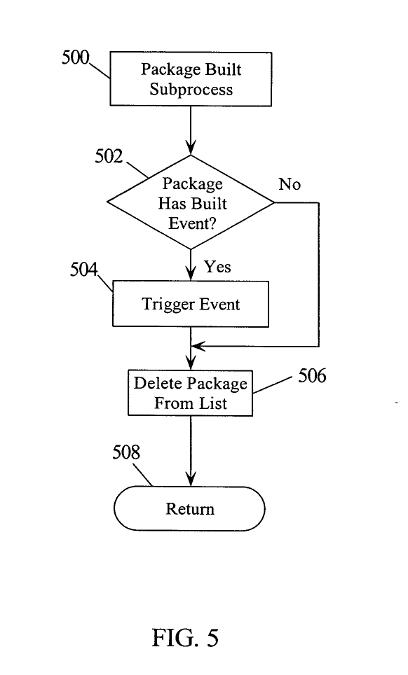

FIG. 5 illustrates a package built subprocess 500 which may be used in conjunction with step 430, FIG. 4.

In step 502, it is determined if a build event has been specified for the package. Recall that the name of a build event may be set in the entry of the package list corresponding to the package being built. If a build event has been specified, the event is triggered in step 504. (In an embodiment of the present invention using the STAF semaphore service discussed above, the event may be triggered by posting the named event.) Otherwise, if no build event is specified, step 504 is bypassed.

In step 506, the entry corresponding to the file package is deleted from the package list, such as list 300, FIG. 3. Subprocess 500 returns in step 508.

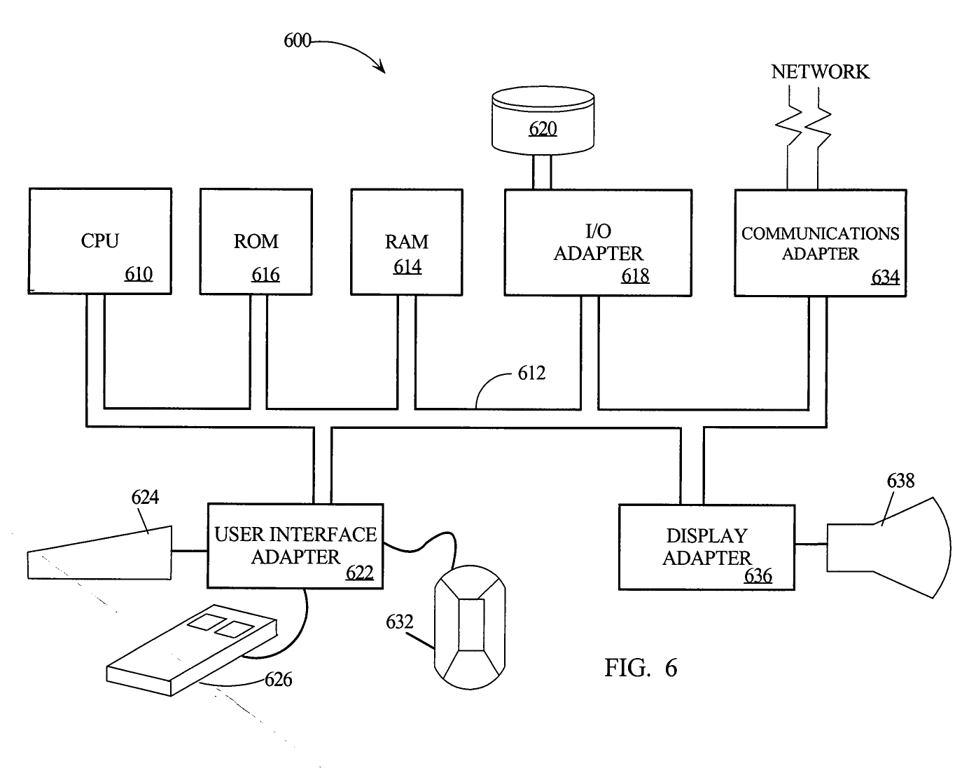

FIG. 6 illustrates an exemplary hardware configuration of data processing system 600 in accordance with the subject invention. The system in conjunction with the methodologies illustrated in FIGS. 2-4 may be used, to build a public file package incorporating application files based on the runtime environment in accordance with the present inventive principles. Data processing system 600 includes central processing unit (CPU) 610, such as a conventional microprocessor, and a number of other units interconnected via system bus 612. Data processing system 600 also includes random access memory (RAM) 614, read only memory (ROM) 616 and input/output (I/O) adapter 618 for connecting peripheral devices such as disk units 620 to bus 612, user interface adapter 622 for connecting keyboard 624, mouse 626, trackball 632 and/or other user interface devices such as a touch screen device (not shown) to bus 612. System 600 also includes communication adapter 634 for connecting data processing system 600 to a data processing network, enabling the system to communicate with other systems, and display adapter 636 for connecting bus 612 to display device 638. CPU 610 may include other circuitry not shown herein, which will include circuitry commonly found within a microprocessor, e.g. execution units, bus interface units, arithmetic logic units, etc. CPU 610 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 614 of one or more computer systems configured generally as described above. These sets of instructions, in conjunction with system components that execute them may effect the building of a public file package as described hereinabove. Until required by the computer system, the set of instructions may be stored as a computer program product in another computer memory, for example, in disk drive 620 (which may include a removable memory such as an optical disk or floppy disk for eventual use in the disk drive 620). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

1. A method for building file packages comprising:
receiving a build request including a first set of file package parameters from a builder process;
if said set of parameters includes a file specification:
accessing a file repository containing a corresponding file; and
storing said file in said file package; and
setting a state of said builder process to a first value, wherein said first value is a member of a predetermined set of builder process states, said first value indicating an initial state of said builder process.

2. The method of claim 1 further comprising:
initiating a creation of the file package in response to user input, wherein said user input includes a second set of file package parameters; and
inserting an entry corresponding to the file package into a package list, said entry including a field operable for containing a builder list, wherein the builder list is further operable for containing said state of said builder process and one or more builder identifiers included in said second set of file package parameters.

3. The method of claim 1 wherein said step of storing said file in said file package comprises sending a request to create a file to a public package server, wherein said request includes said file specification.

4. The method of claim 2 further comprising:
determining if a package name in said first set of file package parameters is contained in an entry in said package list; and
returning with a failure if said package name is not included in said package list.

5. The method of claim 2 further comprising:
determining a current state of said builder process in response to a builder state contained in said builder list;
if said builder state is a second value indicating said builder process is completed, returning with a failure;
if said builder state has said first value, said state in said setting step comprises a third value indicating that said builder process is building the file package.

6. The method of claim 5 further comprising:
determining if all builder processes of a set of builder processes for said file package are in a state having said second value; and
if all said builders processes are in a state having said second value, triggering a corresponding event.

7. The method of claim 6 further comprising:
creating an event if said second set of file package parameters includes a build event parameter, wherein said corresponding event comprises a parameter value of said build event parameter, and wherein said entry corresponding to the file package includes a field operable for containing said parameter value of said build event parameter.

8. A computer program product embodied in a tangible storage medium for building file packages, the program product comprising programming instructions for:
receiving a build request including a first set of file package parameters from a builder process;
if said set of parameters includes a file specification:
accessing a file repository containing a corresponding file;
storing said file in said file package; and
setting a state of said builder process to a first value, wherein said first value is a member of a predetermined set of builder process states, said first value indicating an initial state of said builder process.

9. The computer program product of claim 8 further comprising programming instructions for:
initiating a creation of the file package in response to user input, wherein said user input includes a second set of file package parameters; and
inserting an entry corresponding to the file package into a package list, said entry including a field operable for containing a builder list, wherein the builder list is further operable for containing said state of said builder process and one or more builder identifiers included in said second set of file package parameters.

10. The computer program product of claim 8 wherein said programming instructions for storing said file in said file package comprise programming instructions for sending a request to create a file to a public package server, wherein said request includes said file specification.

11. The computer program product of claim 9 further comprising programming instructions for:
determining if a package name in said first set of file package parameters is contained in an entry in said package list; and
returning with a failure if said package name is not included in said package list.

12. The program product of claim 9 further comprising programming instructions for:
determining a current state of said builder process in response to a builder state contained in said builder list;
if said builder state is a second value indicating said builder process is completed, returning with a failure;
if said builder state has said first value, said state in said setting step comprises a third value indicating that said builder process is building the file package.

13. The program product of claim 12 further comprising programming instructions for:
determining if all builder processes of a set of builder processes for said file package are in a state having said second value; and
if all said builders processes are in a state having said second value, triggering a corresponding event.

14. The program product of claim 13 further comprising programming instructions for:
creating an event if said second set of file package parameters includes a build event parameter, wherein said corresponding event comprises a parameter value of said build event parameter, and wherein said entry corresponding to the file package includes a field operable for containing said parameter value of said build event parameter.

15. A data processing system for building file packages comprising:
circuitry operable for receiving a build request including a first set of file package parameters from a builder process;
circuitry operable for, if said set of parameters includes a file specification:
accessing a file repository containing a corresponding file;
storing said file in said file package; and
circuitry operable for setting a state of said builder process to a first value, wherein said first value is a member of a predetermined set of builder process states, said first value indicating an initial state of said builder process.

16. The data processing system of claim 15 further comprising:
circuitry operable for initiating a creation of the file package in response to user input, wherein said user input includes a second set of file package parameters; and
circuitry operable for inserting an entry corresponding to the file package into a package list, said entry including a field operable for containing a builder list, wherein the builder list is further operable for containing said state of said builder process and one or more builder identifiers included in said second set of file package parameters.

17. The data processing system of claim 15 wherein said circuitry operable for storing said file in said file package comprises circuitry operable for sending a request to create a file to a public package server, wherein said request includes said file specification.

18. The data processing system of claim 16 further comprising:
circuitry operable for determining if a package name in said first set of file package parameters is contained in an entry in said package list; and
circuitry operable for returning with a failure if said package name is not included in said package list.

19. The data processing system of claim 16 further comprising:
circuitry operable for determining a current state of said builder process in response to a builder state contained in said builder list;
circuitry operable for, if said builder state is a second value indicating said builder process is completed, returning with a failure;
circuitry operable for, if said builder state has said first value, said state in said setting step comprises a third value indicating that said builder process is building the file package.

20. The data processing system of claim 19 further comprising:
circuitry operable for determining if all builder processes of a set of builder processes for said file package are in a state having said second value; and
circuitry operable for, if all said builders processes are in a state having said second value, triggering a corresponding event; and
circuitry operable for creating an event if said second set of file package parameters includes a build event parameter, wherein said corresponding event comprises a parameter value of said build event parameter, and wherein said entry corresponding to the file package includes a field operable for containing said parameter value of said build event parameter.
